(19) United States
(12) Patent Application Publication
(10) Pub. No.: US 2026/0178005 A1
(43) Pub. Date: Jun. 25, 2026

(54) Debugging Method and Apparatus for Servo Drive System

(71) Applicant: Siemens Aktiengesellschaft, München (DE)

(72) Inventors: Ming Jie, Beijing (CN); Peng Zhang, Beijing (CN); Shang Ke Feng, Beijing (CN); Ming Yu Tang, Beijing (CN)

(73) Assignee: Siemens Aktiengesellschaft, München (DE)

(21) Appl. No.: 19/125,524

(22) PCT Filed: Oct. 31, 2022
(86) PCT No.: PCT/CN2022/128632

§ 371 Date: Apr. 29, 2025

(51) Int. Cl. G05B 19/401; G05B 19/409; G05B 19/4093

(52) U.S. Cl. CPC G05B 19/401; G05B 19/409; G05B 19/40937

(57) ABSTRACT

Some embodiments include a debugging method for a servo drive system having a driver, a servo motor, and a transmission mechanism with a base having a first identification code, wherein a load with a second identification code is applied to the transmission mechanism. An example includes: acquiring a real-time video of the transmission mechanism and the load from a mobile terminal and identifying the first and the second identification code from the real-time video; calculating a relative position of the load in a coordinate system of the base using the identified identification codes; accepting a user's movement operation for the transmission mechanism on the mobile terminal; and if the transmission mechanism moves in response to the operation, calculating a pulse equivalent according to a position of the load in the coordinate system of the base and an encoder pulse, and writing the equivalent into the driver.

### CROSS-REFERENCE TO RELATED APPLICATIONS

This application is a U.S. National Stage Application of International Application No. PCT/CN2022/128632 filed Oct. 31, 2022, which designates the United States of America, the contents of which are hereby incorporated by reference in their entirety.

### TECHNICAL FIELD

The present disclosure relates to electrical devices. Various embodiments of the teachings herein include systems and/or methods for debugging a servo drive system.

### BACKGROUND

Servo drive systems are widely used in the field of automation to move and rotate a load precisely using a transmission mechanism (for example, a ball screw, a gear, and a synchronous belt). In the process of installation and debugging of the servo drive system, it is necessary to set mechanical parameters (for example, a transmission ratio) and debugging control parameters (for example, PID parameters of current/speed/position circuit), which requires an engineer to have professional knowledge and consumes a lot of time.

Some manufacturers provide debugging tools to speed up the debugging process. In addition, some servo drive systems also have automatic debugging functions, but these servo drive systems only obtain information such as position and current from an encoder and a motor, and do not have information about a transmission system and a load, and the engineer still needs to manually debug the servo drive systems. Furthermore, some manufacturers use a variety of analysis methods to debug the transmission system and the load based on data, such as using the reinforcement learning algorithm to optimize the PID parameters or debugging the servo drive system based on frequency domain analysis. However, such methods require related information of the transmission system and the load, and additional sensors are required to obtain the information, which may increase the cost of system debugging.

### SUMMARY

To address the technical problems above, the present disclosure describes debugging methods and/or apparatus for a servo drive system to achieve low-cost, intuitive, and more convenient debugging of the system. For example, some embodiments of the teachings herein include a debugging method (100) for a servo drive system, wherein the servo drive system comprises a driver, a servo motor, and a transmission mechanism; the transmission mechanism comprises a base, and a load is provided on the transmission mechanism; and the base is provided with a first identification code, and the load is provided with a second identification code, wherein the debugging method (100) comprises: acquiring a real-time video of the transmission mechanism and the load from a mobile terminal, and identifying the first identification code and the second identification code the real-time video (110); calculating a relative position of the load in a base coordinate system of the base according to the identified first identification code and second identification code (120); and accepting a user's movement operation for the transmission mechanism on the mobile terminal, and in a case that the transmission mechanism moves in response to the operation, calculating a pulse equivalent according to a position of the load in the base coordinate system of the base and an encoder pulse, and writing the pulse equivalent into the driver (130).

In some embodiments, the method (100) further comprises: detecting a mechanical resonance of the transmission mechanism in the real-time video by using an optical flow method, calculating a resonant frequency of the mechanical resonance, and writing the resonant frequency into the driver as a resonant filter parameter.

In some embodiments, the method (100) further comprises: accepting a safety operation area of the transmission mechanism set by the user in the mobile terminal, and limiting a movement range of the transmission mechanism in the safety operation area.

In some embodiments, calculating a relative position of the load in a base coordinate system of the base according to the identified first identification code and second identification code comprises: calculating a first transformation relationship between a camera coordinate system of the mobile terminal and the base coordinate system according to a position of the first identification code in the video; calculating a second transformation relationship between the camera coordinate system of the mobile terminal and a load coordinate system according to a position of the second identification code in the video; and calculating the relative position of the load in the base coordinate system of the base according to the first transformation relationship and the second transformation relationship.

In some embodiments, the driver and the mobile terminal are connected to an edge device, and the method (100) further comprises: transmitting, by the mobile terminal, a control instruction and a configuration parameter to the driver through the edge device.

As another example, some embodiments include a debugging apparatus (300) for a servo drive system, wherein the servo drive system comprises a driver, a servo motor, and a transmission mechanism; the transmission mechanism comprises a base, and a load is provided on the transmission mechanism; and the base is provided with a first identification code, and the load is provided with a second identification code, wherein the debugging apparatus (300) comprises: an acquisition module (310), configured to acquire a real-time video of the transmission mechanism and the load from a mobile terminal, and identify the first identification code and the second identification code from the real-time video; an identification module (320), configured to calculate a relative position of the load in a base coordinate system of the base according to the identified first identification code and second identification code; and a calculation module (330), configured to accept a user's movement operation for the transmission mechanism on the mobile terminal, and in a case that the transmission mechanism moves in response to the operation, calculate a pulse equivalent according to a position of the load in the base coordinate system of the base and an encoder pulse, and write the pulse equivalent into the driver.

In some embodiments, the apparatus (300) further comprises: detecting a mechanical resonance of the transmission mechanism in the real-time video by using an optical flow method, calculating a resonant frequency of the mechanical resonance, and writing the resonant frequency into the driver as a resonant filter parameter.

In some embodiments, the apparatus (300) further comprises: accepting a safety operation area of the transmission mechanism set by the user in the mobile terminal, and limiting a movement range of the transmission mechanism in the safety operation area.

In some embodiments, the identification module (320) calculating a relative position of the load in a base coordinate system of the base according to the identified first identification code and second identification code comprises: calculating a first transformation relationship between a camera coordinate system of the mobile terminal and the base coordinate system according to a position of the first identification code in the video; calculating a second transformation relationship between the camera coordinate system of the mobile terminal and a load coordinate system according to a position of the second identification code in the video; and calculating the relative position of the load in the base coordinate system of the base according to the first transformation relationship and the second transformation relationship.

In some embodiments, the driver and the mobile terminal are connected to an edge device, and the apparatus (300) further comprises: the mobile terminal transmits a control instruction and a configuration parameter to the driver through the edge device.

As another example, some embodiments include a debugging apparatus for a servo drive system, wherein the servo drive system comprises a driver, a servo motor, and a transmission mechanism; the transmission mechanism comprises a base, and a load is provided on the transmission mechanism; and the base is provided with a first identification code, and the load is provided with a second identification code, wherein the debugging apparatus comprises: a mobile terminal, configured to acquire a real-time video of the transmission mechanism and the load from the mobile terminal, and identify the first identification code and the second identification code from the real-time video; calculate a relative position of the load in a base coordinate system of the base according to the identified first identification code and second identification code; and accept a user's movement operation for the transmission mechanism on the mobile terminal, and in a case that the transmission mechanism moves in response to the operation, calculate a pulse equivalent according to a position of the load in the base coordinate system of the base and an encoder pulse, and write the pulse equivalent into the driver.

As another example, some embodiments include an electronic device (400), comprising a processor (410), a memory (420), and instructions stored in the memory (420), wherein the instructions, when executed by the processor (410), implement one or more of the methods described herein.

As another example, some embodiments include a computer-readable storage medium, having computer instructions stored thereon, wherein the computer instructions, when run, implement one or more of the methods described herein.

As another example, some embodiments include a computer program product, comprising computer programs, wherein the computer programs, when executed by a processor, implement one or more of the methods described herein.

### BRIEF DESCRIPTION OF THE DRAWINGS

The following drawings are only intended to illustrate and explain the present disclosure schematically, and do not limit the scope thereof. In the drawings:

FIG. 1 is a flowchart of an example debugging method for a servo drive system incorporating teachings of the present disclosure;

FIG. 2 is a schematic diagram of an example debugging method for a servo drive system incorporating teachings of the present disclosure;

FIG. 3 is a schematic diagram of an example debugging apparatus for a servo drive system incorporating teachings of the present disclosure; and

FIG. 4 is a schematic diagram of an example electronic device incorporating teachings of the present disclosure.

### DESCRIPTION OF REFERENCE NUMERALS

100 Debugging method for servo drive system
110-140 Step
21 Driver
22 Servo motor
221 Encoder
23 Transmission mechanism
231 Base
24 Load
25 Mobile terminal
26 Edge device
A First identification code
B Second identification code
300 Debugging apparatus for servo drive system
400 Electronic device
410 Processor
420 Memory

### DETAILED DESCRIPTION

To address the foregoing purposes, the present disclosure describes debugging methods for a servo drive system. A typical servo drive system includes a driver, a servo motor, and a transmission mechanism. The transmission mechanism includes a base, and a load is provided on the transmission mechanism. The base is provided with a first identification code, and the load is provided with a second identification code. An example debugging method includes: acquiring a real-time video of the transmission mechanism and the load from a mobile terminal, and identifying the first identification code and the second identification code from the real-time video; calculating a relative position of the load in a base coordinate system of the base according to the identified first identification code and second identification code; and accepting a user's movement operation for the transmission mechanism on the mobile terminal, and in a case that the transmission mechanism moves in response to the operation, calculating a pulse equivalent according to a position of the load in the base coordinate system of the base and an encoder pulse, and writing the pulse equivalent into the driver. In view of this, by using the mobile terminal to acquire the real-time video of the transmission mechanism and the load in the servo drive system, the real-time position of the transmission mechanism and the load may be detected according to the real-time video of the transmission mechanism and the load, without setting additional sensors, thereby saving hardware costs, and the debugging process is controlled by a mobile phone, which makes the debugging process more intuitive and easier to operate.

In some embodiments, the method further includes: detecting a mechanical resonance of the transmission mechanism in the real-time video by using an optical flow method, calculating a resonant frequency of the mechanical resonance, and writing the resonant frequency into the driver as a resonant filter parameter. In view of this, the mechanical resonance of the transmission mechanism is detected in the real-time video by using the optical flow method, realizing calibration of the resonant parameter in the driver.

In some embodiments, the debugging method further includes: accepting a safety operation area of the transmission mechanism set by the user in the mobile terminal, and limiting a movement range of the transmission mechanism in the safety operation area. In view of this, the user may complete the setting of the safety operation area of the transmission mechanism through the mobile terminal, which makes the debugging process more intuitive and easier to operate.

In some embodiments, the calculating a relative position of the load in a base coordinate system of the base according to the identified first identification code and second identification code includes: calculating a first transformation relationship between a camera coordinate system of the mobile terminal and the base coordinate system according to a position of the first identification code in the video; calculating a second transformation relationship between the camera coordinate system of the mobile terminal and a load coordinate system according to a position of the second identification code in the video; and calculating the relative position of the load in the base coordinate system of the base according to the first transformation relationship and the second transformation relationship. In view of this, the calculation of the relative position of the load in the base coordinate system of the base is realized.

In some embodiments, the driver and the mobile terminal are connected to an edge device, and the method further includes: transmitting, by the mobile terminal, a control instruction and a configuration parameter to the driver through the edge device. In view of this, the mobile terminal transmits the control instruction and the configuration parameter to the driver through the edge device, which realizes the communication between the mobile terminal and the driver and improves the communication efficiency between the mobile terminal and the driver through edge connection.

In some embodiments, there is a debugging apparatus for a servo drive system. The servo drive system includes a driver, a servo motor, and a transmission mechanism. The transmission mechanism includes a base, and a load is provided on the transmission mechanism. The base is provided with a first identification code, and the load is provided with a second identification code. An example debugging apparatus includes: an acquisition module, configured to acquire a real-time video of the transmission mechanism and the load from a mobile terminal, and identify the first identification code and the second identification code from the real-time video; an identification module, configured to calculate a relative position of the load in a base coordinate system of the base according to the identified first identification code and second identification code; and a calculation module, configured to accept a user's movement operation for the transmission mechanism on the mobile terminal, and in a case that the transmission mechanism moves in response to the operation, calculate a pulse equivalent according to a position of the load in the base coordinate system of the base and an encoder pulse, and write the pulse equivalent into the driver.

In some embodiments, the apparatus further includes: detecting a mechanical resonance of the transmission mechanism in the real-time video by using an optical flow method, calculating a resonant frequency of the mechanical resonance, and writing the resonant frequency into the driver as a resonant filter parameter.

In some embodiments, the apparatus further includes: accepting a safety operation area of the transmission mechanism set by the user in the mobile terminal, and limiting a movement range of the transmission mechanism in the safety operation area.

In some embodiments, the identification module calculating a relative position of the load in a base coordinate system of the base according to the identified first identification code and second identification code includes: a first calculating transformation relationship between a camera coordinate system of the mobile terminal and the base coordinate system according to a position of the first identification code in the video; calculating a second transformation relationship between the camera coordinate system of the mobile terminal and a load coordinate system according to a position of the second identification code in the video; and calculating the relative position of the load in the base coordinate system of the base according to the first transformation relationship and the second transformation relationship.

In some embodiments, the driver and the mobile terminal are connected to an edge device, and the apparatus further includes: the mobile terminal transmits a control instruction and a configuration parameter to the driver through the edge device.

Some embodiments include a debugging apparatus for a servo drive system. The servo drive system includes a driver, a servo motor, and a transmission mechanism. The transmission mechanism includes a base, and a load is provided on the transmission mechanism. The base is provided with a first identification code, and the load is provided with a second identification code. An example debugging apparatus includes: a mobile terminal, configured to acquire a real-time video of the transmission mechanism and the load from the mobile terminal, and identify the first identification code and the second identification code from the real-time video; calculate a relative position of the load in a base coordinate system of the base according to the identified first identification code and second identification code; and accept a user's movement operation for the transmission mechanism on the mobile terminal, and in a case that the transmission mechanism moves in response to the operation, calculate a pulse equivalent according to a position of the load in the base coordinate system of the base and an encoder pulse, and write the pulse equivalent into the driver.

Some embodiments include an electronic device, including a processor, a memory, and instructions stored in the memory, where the instructions, when executed by the processor, implement one or more of the methods as described herein.

Some embodiments include a computer-readable storage medium, having computer instructions stored thereon, where the computer instructions, when run, implement one or more of the methods as described herein.

Some embodiments include a computer program product, including computer programs, where the computer programs, when executed by a processor, implement one or more of the methods as described herein.

For a clearer understanding of the technical features, objectives and effects of teachings of the present disclosure, some specific implementations are described with reference to the accompanying drawings now. Numerous specific details are set forth in the following description to facilitate a full understanding, but the teachings may also be implemented in other ways than those described herein, and thus the present disclosure is not limited by the specific embodiments disclosed below.

As shown in this application and the Claims, unless the context clearly dictates otherwise, the terns “a/an”, “one”, “a/an” and/or “the” are not intended to be specific in the singular and may include the plural. Generally speaking, the terms “including” and “comprising” only imply that the clearly identified elements are included, and these steps and elements do not constitute an exclusive list, and the method or device may also include other steps or elements.

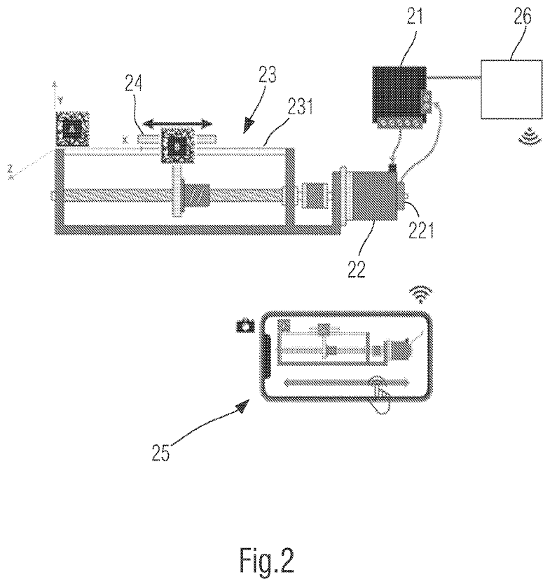

FIG. 2 is a schematic diagram of an example debugging method for a servo drive system incorporating teachings of the present disclosure. As shown in FIG. 2, the servo drive system includes a driver 21, a servo motor 22, and a transmission mechanism 23. A motor encoder 221 is installed on the motor 22 to measure the position of a magnetic pole and a rotational speed of the motor's rotation angle. The transmission mechanism 23 may also be referred to as a transmission chain, which may be a roller screw, a gear, and a synchronous belt, etc. The transmission mechanism 23 includes a base 231, and a load 24 is provided on the transmission mechanism 23. The coordinate system where the base 231 is located is a base coordinate system. The driver 21 may drive the servo motor 22 to rotate, and the rotation of the servo motor 22 may move the load 24 provided on the transmission mechanism 23 through the transmission mechanism 23. The base 231 is provided with a first identification code A, and the load is provided with a second identification code B. The first identification code A is used for identifying the base 231 of the transmission mechanism 23, and the second identification code B is used for identifying the load 24 on the transmission mechanism 23. In embodiments of the present invention, the first identification code A and the second identification code B may be QR codes.

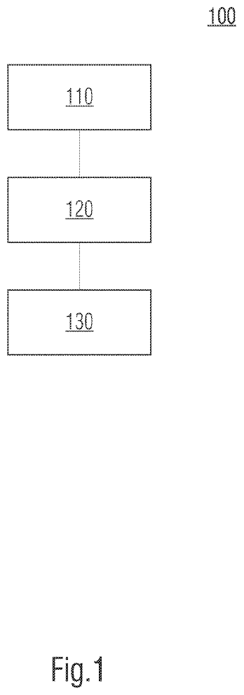

Some embodiments include a debugging method for a servo drive system. FIG. 1 is a flowchart of an example debugging method 100 for a servo drive system incorporating teachings of the present disclosure. As shown in FIG. 1, the debugging method 100 includes: Step 110: Acquire a real-time video of a transmission mechanism and a load from a mobile terminal and identify a first identification code and a second identification code from the real-time video. The mobile terminal 25 may be a hardware device such as a mobile phone or a tablet computer. The mobile terminal 25 has a camera and a display. By adjusting the position and posture of the mobile terminal 25, the transmission mechanism 23 and the load 24 are located within the field of view of the camera of the mobile terminal, and the camera of the mobile terminal 25 then collects the real-time video of the transmission mechanism 23 and the load 24. The real-time video includes a first identification code A provided on the base 231 of the transmission mechanism 23 and a second identification code B provided on the load 24. The first identification code A and the second identification code B are identified from the real-time video.

Step 120: Calculate a relative position of the load in a base coordinate system of the base according to the identified first identification code and second identification code. The first identification code A corresponds to the position of the base 231 of the transmission mechanism 23, and the second identification code B corresponds to the position of the load 24. Transformation calculation is performed on the first identification code A and the second identification code B through the first identification code A and the second identification code B that are identified from the real-time video, to obtain the relative position of the load 24 in the base coordinate system of the base 231.

In some embodiments, calculating a relative position of the load 24 in a base coordinate system of the base 231 according to the identified first identification code A and second identification code B may include: calculating a first transformation relationship between a camera coordinate system of the mobile terminal 25 and the base coordinate system according to a position of the first identification code A in the video; calculating a second transformation relationship between the camera coordinate system of the mobile terminal and a load coordinate system according to a position of the second identification code B in the video; and calculating the relative position of the load 24 in the base coordinate system of the base 231 according to the first transformation relationship and the second transformation relationship. Specifically, the relative position of the load 24 in the base coordinate system of the base 231 may be calculated according to the first transformation relationship and the second transformation relationship by using a directional cosine matrix or a quaternion method. In view of this, the calculation of the relative position of the load in the base coordinate system of the base is realized.

Step 130: Accept a user's movement operation for the transmission mechanism on the mobile terminal, and in a case that the transmission mechanism moves in response to the operation, calculate a pulse equivalent according to a position of the load in the base coordinate system of the base and an encoder pulse, and write the pulse equivalent into the driver. The user may drag the load 24 displayed on the display of the mobile terminal 25, the instruction may be transmitted to the driver 21 through the edge device 26, the driver 21 drives the motor 22 to rotate according to the instruction, the motor 22 outputs a torque to the transmission mechanism 23, and the transmission mechanism 23 drives the load 24 to move, the user may also input a speed instruction in the mobile terminal 25, and the load 24 may move according to the speed inputted by the user in the mobile terminal 25. During the movement of the load 24, a linear movement distance LU of the load may be calculated according to the position of the load in the base coordinate system of the base obtained in step 120, and a corresponding pulse number is obtained from the motor encoder 221. The pulse equivalent is calculated by dividing the number of pulses by the linear moving distance, and the calculated pulse equivalent is written into the driver, thereby completing the calibration of the pulse equivalent of the driver.

In some embodiments, the method 100 further includes: detecting a mechanical resonance of the transmission mechanism in the real-time video by using an optical flow method, calculating a resonant frequency of the mechanical resonance, and writing the resonant frequency into the driver as a resonant filter parameter. Specifically, in the embodiments, a mechanical resonance of the transmission mechanism 23 is detected in the real-time video by using an optical flow method, a resonant frequency of the mechanical resonance is calculated, and the resonant frequency is written into the driver 21 as a resonant filter parameter. In view of this, the mechanical resonance of the transmission mechanism is detected in the real-time video by using the optical flow method, realizing calibration of the resonant parameter in the driver.

In some embodiments, the method 100 further includes: accepting a safety operation area of the transmission mechanism set by the user in the mobile terminal, and limiting a movement range of the transmission mechanism in the safety operation area. Specifically, the user may operate in the mobile terminal 25 to define the movement range of the transmission mechanism 23, that is, the boundary of the movement of the transmission mechanism 23. The safety operation area is transmitted by the mobile terminal 25 to the driver 21. Drive parameters of the driver 21 are configured according to the safety operation area, and the movement range of the transmission mechanism 23 is limited in the safety operation area.

In some embodiments, the driver and the mobile terminal are connected to an edge device. The method 100 further includes: transmitting, by the mobile terminal, a control instruction and a configuration parameter to the driver through the edge device. Specifically, the mobile terminal 25 may be connected to the edge device 26 through Wi-Fi, the edge device 26 may be connected to the driver 21 through a Profinet protocol, the control instruction and the configuration parameter of the mobile terminal 25 are transmitted to the edge device 26 through Wi-Fi, the edge device 26 transmits the control instruction and the configuration parameter to the driver 21 according to the Profinet protocol, and the driver 21 configures the driving parameters according to the control instruction and configuration parameter. In view of this, the mobile terminal transmits the control instruction and the configuration parameter to the driver through the edge device, which realizes the communication between the mobile terminal and the driver, and improves the communication efficiency between the mobile terminal and the driver through edge connection.

Some embodiments of the teachings herein include a debugging method for a servo drive system. By using the mobile terminal to acquire the real-time video of the transmission mechanism and the load in the servo drive system, the real-time position of the transmission mechanism and the load may be detected according to the real-time video of the transmission mechanism and the load, without setting additional sensors, thereby saving hardware costs, and the debugging process is controlled by a mobile phone, which makes the debugging process more intuitive and easier to operate.

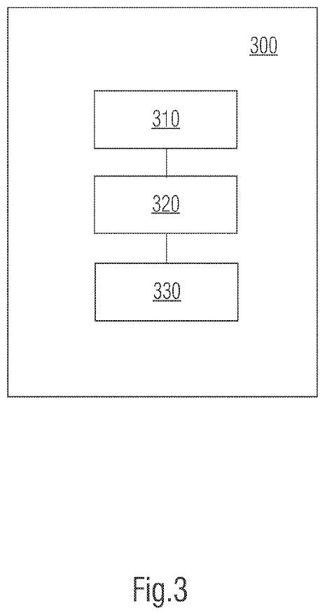

Some embodiments include a debugging apparatus for a servo drive system. FIG. 3 is a schematic diagram of an example debugging apparatus 300 for a servo drive system incorporating teachings of the present disclosure. The servo drive system includes a driver, a servo motor, and a transmission mechanism. The transmission mechanism includes a base, and a load is provided on the transmission mechanism. The base is provided with first identification code, and the load is provided with a second identification code, where the debugging apparatus 300 includes: an acquisition module 310, configured to acquire a real-time video of the transmission mechanism and the load from a mobile terminal, and identify the first identification code and the second identification code from the real-time video; an identification module 320, configured to calculate a relative position of the load in a base coordinate system of the base according to the identified first identification code and second identification code; and a calculation module 330, configured to accept a user's movement operation for the transmission mechanism on the mobile terminal, and in a case that the transmission mechanism moves in response to the operation, calculate a pulse equivalent according to a position of the load in the base coordinate system of the base and an encoder pulse, and write the pulse equivalent into the driver.

In some embodiments, the apparatus further includes: detecting a mechanical resonance of the transmission mechanism in the real-time video by using an optical flow method, calculating a resonant frequency of the mechanical resonance, and writing the resonant frequency into the driver as a resonant filter parameter.

In some embodiments, the apparatus further includes: accepting a safety operation area of the transmission mechanism set by the user in the mobile terminal, and limiting a movement range of the transmission mechanism in the safety operation area.

In some embodiments, the identification module calculating a relative position of the load in a base coordinate system of the base according to the identified first identification code and second identification includes: code calculating a first transformation relationship between a camera coordinate system of the mobile terminal and the base coordinate system according to a position of the first identification code in the video; calculating a second transformation relationship between the camera coordinate system of the mobile terminal and a load coordinate system according to a position of the second identification code in the video; and calculating the relative position of the load in the base coordinate system of the base by using a directional cosine matrix according to the first transformation relationship and the second transformation relationship.

In some embodiments, the driver and the mobile terminal are connected to an edge device and the apparatus further includes: the mobile terminal transmits a control instruction and a configuration parameter to the driver through the edge device.

Some embodiments include a debugging apparatus for a servo drive system. The servo drive system includes a driver, a servo motor, and a transmission mechanism. The transmission mechanism includes a base, and a load is provided on the transmission mechanism. The base is provided with a first identification code, and the load is provided with a second identification code. The debugging apparatus includes a mobile terminal.

The mobile terminal is configured to acquire a real-time video of the transmission mechanism and the load from the mobile terminal, and identify the first identification code and the second identification code from the real-time video; calculate a relative position of the load in a base coordinate system of the base according to the identified first identification code and second identification code; and accept a user's movement operation for the transmission mechanism on the mobile terminal, and in a case that the transmission mechanism moves in response to the operation, calculate a pulse equivalent according to a position of the load in the base coordinate system of the base and an encoder pulse, and write the pulse equivalent into the driver.

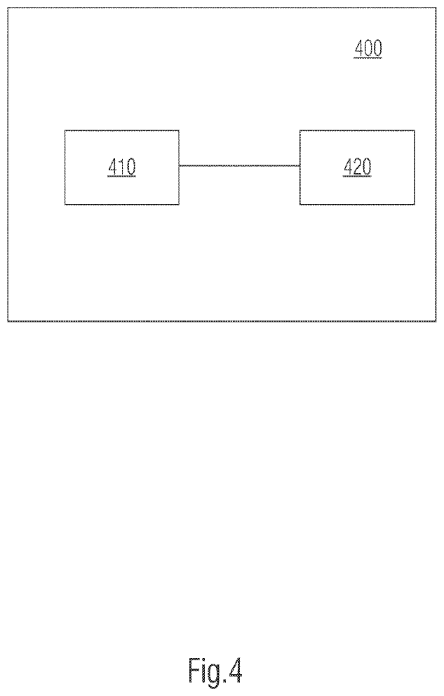

Some embodiments include an electronic device 400. FIG. 4 is a schematic diagram of example an electronic device 400 incorporating teachings of the present disclosure. As shown in FIG. 4, the electronic device 400 includes a processor 410 and a memory 420. Instructions are stored in the memory 420, where the instructions, when executed by the processor 410, implement one or more of the methods as described above.

Some embodiments include a computer-readable storage medium, having computer instructions stored thereon, where the computer instructions, when run, implement one or more of the methods as described above.

Some embodiments include a computer program product, including computer programs, where the computer programs, when executed by a processor, implement one or more of the methods as described above.

Some aspects of the methods and/or apparatus may be executed entirely by hardware, entirely by software (including firmware, resident software, microcode, etc.), or by a combination of hardware and software. The above hardware or software may be referred to as a “data block”, “module”, “engine”, “unit”, “assembly” or “system”. The processor may be one or more application-specific integrated circuits (ASICs), digital signal processors (DSPs), digital signal processing devices (DAPDs), programmable logic devices (PLCs), field programmable gate arrays (FPGAS), processors, controllers, microcontrollers, microprocessors, or a combination thereof. Furthermore, aspects of the present invention may be embodied as a computer product located in one or more computer-readable media. The product includes computer-readable program codes. For example, the computer-readable media may include, but are not limited to, magnetic storage devices (e.g., hard disks, floppy disks, and magnetic tapes), optical disks (e.g., compact disks (CDs) (, and digital versatile disks (DVDs)), smart cards and flash memory devices (e.g., cards, sticks, and key drives).

Flowcharts are used herein to illustrate operations performed in the methods incorporating teachings of this disclosure. It is to be understood that the preceding operations are not necessarily performed in exact order. In contrast, the elements may be processed in reverse order or concurrently. Moreover, other operations are added to these processes, or a certain step or steps are removed from these processes.

Although the specification is described according to various embodiments, not every embodiment only includes an independent technical solution, and the description in the specification is only for the sake of clarity, and a person skilled in the art should take the specification as a whole, the technical solution in each embodiment may also be appropriately combined to form other implementations that may be understood by a person skilled in the art.

The above are only exemplary specific implementations of the present disclosure and are not intended to limit the scope thereof. Any equivalent variations, modifications, and combinations made by any person skilled in the art without departing from the concept and principles of the present disclosure shall fall within the scope of protection thereof.

What is claimed is:

1. A debugging method for a servo drive system having a driver, a servo motor, and a transmission mechanism with a base having a first identification code, wherein a load with a second identification code is applied to the transmission mechanism, comprising:
acquiring a real-time video of the transmission mechanism and the load from a mobile terminal and identifying the first identification code and the second identification code from the real-time video;
calculating a relative position of the load in a coordinate system of the base using the first identification code and second identification code;
accepting a user's movement operation for the transmission mechanism on the mobile terminal; and
if the transmission mechanism moves in response to the operation, calculating a pulse equivalent according to a position of the load in the coordinate system of the base and an encoder pulse, and writing the pulse equivalent into the driver.

2. The debugging method according to claim 1, where further comprising:
detecting a mechanical resonance of the transmission mechanism in the real-time video by using an optical flow method;
calculating a resonant frequency of the mechanical resonance; and
writing the resonant frequency into the driver as a resonant filter parameter.

3. The debugging method according to claim 1, further comprising:
accepting a safety operation area of the transmission mechanism set by the user in the mobile terminal; and
limiting a movement range of the transmission mechanism in the safety operation area.

4. The debugging method according to claim 1, wherein calculating a relative position of the load in a base coordinate system of the base according to the identified first identification code and second identification code comprises:
calculating a first transformation relationship between a camera coordinate system of the mobile terminal and the base coordinate system according to a position of the first identification code in the video;
calculating a second transformation relationship between the camera coordinate system of the mobile terminal and a load coordinate system according to a position of the second identification code in the video; and
calculating the relative position of the load in the base coordinate system of the base according to the first transformation relationship and the second transformation relationship.

5. The debugging method according to claim 1, wherein:
the driver and the mobile terminal are connected to an edge device; and
the method further comprises transmitting a control instruction and a configuration parameter to the driver through the edge device using the mobile terminal.

6. A debugging apparatus for a servo drive system having a driver, a servo motor, and a transmission mechanism with a base having a first identification code; and a load with a second identification code applied on the transmission mechanism, the apparatus comprising:
an acquisition module to acquire a real-time video of the transmission mechanism and the load from a mobile terminal, and identify the first identification code and the second identification code from the real-time video;
an identification module to calculate a relative position of the load in a coordinate system of the base according to the identified first identification code and second identification code; and
a calculation module to accept a user's movement operation for the transmission mechanism on the mobile terminal, and if the transmission mechanism moves in response to the operation, calculate a pulse equivalent according to a position of the load in the base coordinate system of the base and an encoder pulse, and write the pulse equivalent into the driver.

7. The debugging apparatus according to claim 6, further comprising a resonance module to:
detect a mechanical resonance of the transmission mechanism in the real-time video by using an optical flow method;
calculate a resonant frequency of the mechanical resonance; and
write the resonant frequency into the driver as a resonant filter parameter.

8. The debugging apparatus according to claim 6, further comprising a safety module to:
accept a safety operation area of the transmission mechanism set by the user in the mobile terminal; and
limit a movement range of the transmission mechanism in the safety operation area.

9. The debugging apparatus according to claim 6, wherein calculating a relative position of the load in the coordinate system of the base according to the identified first identification code and second identification code comprises:
calculating a first transformation relationship between a camera coordinate system of the mobile terminal and the base coordinate system according to a position of the first identification code in the video;
calculating a second transformation relationship between the camera coordinate system of the mobile terminal and a load coordinate system according to a position of the second identification code in the video; and
calculating the relative position of the load in the base coordinate system of the base according to the first transformation relationship and the second transformation relationship.

10. The debugging apparatus according to claim 6, wherein:
the driver and the mobile terminal are connected to an edge device; and
the edge device transmits a control instruction and a configuration parameter to the driver from the mobile terminal through the edge device.

11. A debugging apparatus for a servo drive system having a driver, a servo motor, and a transmission mechanism with a base having a first identification code, and a load with a second identification code applied on the transmission mechanism, the apparatus comprising:
a mobile terminal to acquire a real-time video of the transmission mechanism and the load from the mobile terminal, and identify the first identification code and the second identification code from the real-time video, calculate a relative position of the load in a base coordinate system of the base according to the identified first identification code and second identification code, and accept a user's movement operation for the transmission mechanism on the mobile terminal, and in a case that the transmission mechanism moves in response to the operation, calculate a pulse equivalent according to a position of the load in the base coordinate system of the base and an encoder pulse, and write the pulse equivalent into the driver.

12-14. (canceled)
